(19) United States
(12) Patent Application Publication
(10) Pub. No.: US 2011/0000380 A1
(43) Pub. Date: Jan. 6, 2011

(54) FOOD STEAMER

(76) Inventor: Will C. Jamison, Carson, CA (US)

Correspondence Address: LITMAN LAW OFFICES, LTD., PATENT LAW BUILDING, 8955 CENTER STREET, MANASSAS, VA, 20110, US

(21) Appl. No.: 12/920,291

(22) PCT Filed: Apr. 6, 2009
(86) PCT No.: PCT/US09/02135

§ 371 Date: Aug. 30, 2010

Related U.S. Application Data
(60) Provisional application No. 61/071,007, filed on Apr. 8, 2008.

(51) Int. Cl. A47J 27/05

(52) U.S. Cl. 99/417; 99/450

(57) ABSTRACT

The food steamer (10) is a cooking device for cooking, heating or reheating food received therein with steam. The food steamer (10) includes a pot (12) having an open interior region adapted for receiving a volume of water therein for boiling. A food receptacle (16) is releasably supported on an upper peripheral edge (13) of the pot (12). The food receptacle (16) includes a lower wall (30) and at least one sidewall (15). The lower wall (30) has a plurality of apertures (34) formed therethrough for the passage of steam therethrough when the volume of water in the pot (12) is boiled. At least one tray (20) is removably received within the food receptacle (16). The at least one tray (20) is adapted for supporting food to be cooked by the steam passing through the plurality of apertures (34). At least one retaining member (32) is mounted within the food receptacle (16) for releasably retaining and positioning the at least one tray (20) therein.

### TECHNICAL FIELD

The present invention relates to cooking appliances, and particularly to a food steamer for cooking, heating or reheating food with steam.

### BACKGROUND ART

Using steam to cook, heat or reheat food is well known. The use of steam affords several benefits over other cooking methods, such as boiling, frying, etc., particularly because no fat (e.g., in the form of cooking oil, butter or margarine) is required in the heating process.

Conventional steamer inserts are designed for use in conventional saucepans, typically having a capacity of about two quarts or more. To use such an insert, the saucepan is first filled with an appropriate amount of water, and then the insert is placed within the saucepan. The bottom surface of the insert is maintained above the level of the water in the saucepan. In some configurations, the steamer has an outturned upper lip that engages the side of the saucepan to support the insert above the level of the water. In other configurations, the steamer insert has legs extending from its bottom surface that support the steamer above the level of the water.

Although these conventional steamer inserts are adequate for some steaming applications (e.g., steaming vegetables) they do not provide the user with great variety in the types of food that may be steamed. The steamer portion is typically provided a single, unitary member, allowing for no control or variation over the quantity of steam applied to the food, or the rate of steam application. Thus, a food steamer solving the aforementioned problems is desired.

### DISCLOSURE OF INVENTION

The food steamer is a cooking device for cooking, heating or reheating food with steam. The food steamer includes a pot having an open interior region adapted for receiving a volume of water therein for boiling. A food receptacle is releasably supported on an upper peripheral edge of the pot. The food receptacle includes a lower wall and at least one sidewall. The lower wall has a plurality of apertures formed therethrough for the passage of steam therethrough when the volume of water in the pot is boiled. A cover is further provided for removably covering and sealing the food receptacle, with the cover being releasably supported on an upper rim of the at least one sidewall.

At least one tray is removably received within the food receptacle. The at least one tray is adapted for supporting food to be cooked by the steam passing through the plurality of apertures. At least one retaining member is mounted within the food receptacle for releasably retaining and positioning the at least one tray therein.

These and other features of the present invention will become readily apparent upon further review of the following specification and drawings.

### BRIEF DESCRIPTION OF THE DRAWINGS

FIG. 1 is a perspective view of a food steamer according to the present invention.

FIG. 2 is an exploded view of the food steamer according to the present invention.

FIG. 3 is a top view of a food receptacle of the food steamer according to the present invention.

FIG. 4 is a plan view of a tray of the food steamer according to the present invention.

FIG. 5 is a top view of the food receptacle and alternative trays of the food steamer according to the present invention.

FIG. 6 is a perspective view of the one of the alternative trays of FIG. 5.

Similar reference characters denote corresponding features consistently throughout the attached drawings.

### BEST MODES FOR CARRYING OUT THE INVENTION

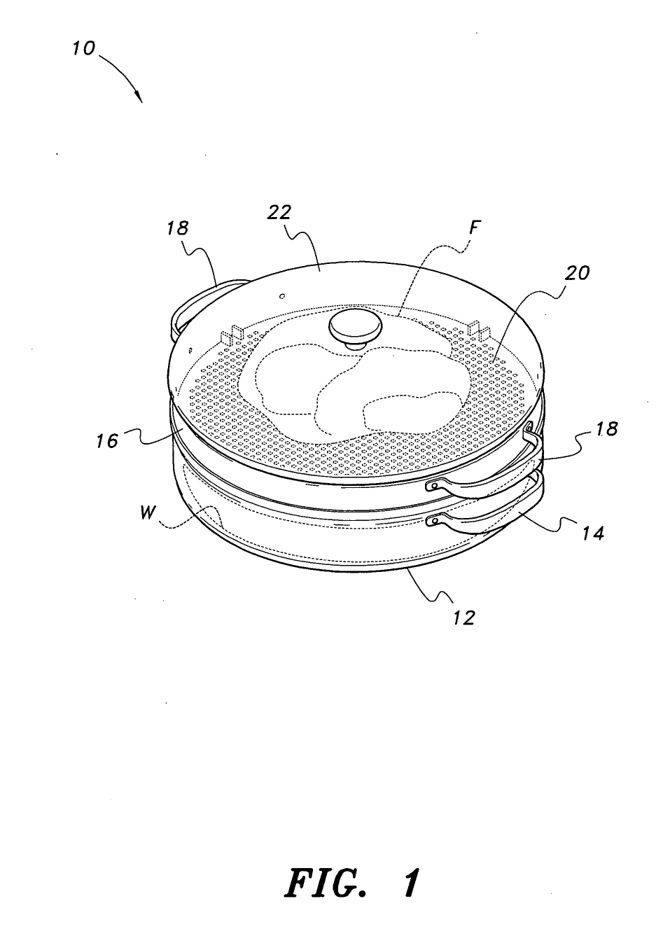

The present invention is directed towards a food steamer 10. As shown in FIG. 1, the food steamer 10 is a cooking device for cooking, heating or reheating food F received therein with steam. The food steamer 10 includes a pot 12 having an open interior region adapted for receiving a volume of water W therein for boiling. The pot may have any desired size or contouring, and is preferably a conventional cooking pot. Pot 12 is preferably formed from metal or any other suitable thermally conductive material. It should be understood that pot 12 is shown in the Drawings for exemplary purposes only. In the preferred embodiment, pot 12 (along with food receptacle 16 and cover 22, to be described in greater detail below) has a substantially circular cross-sectional contour. Pot 12 may have one or more handles 14 mounted thereto, as shown.

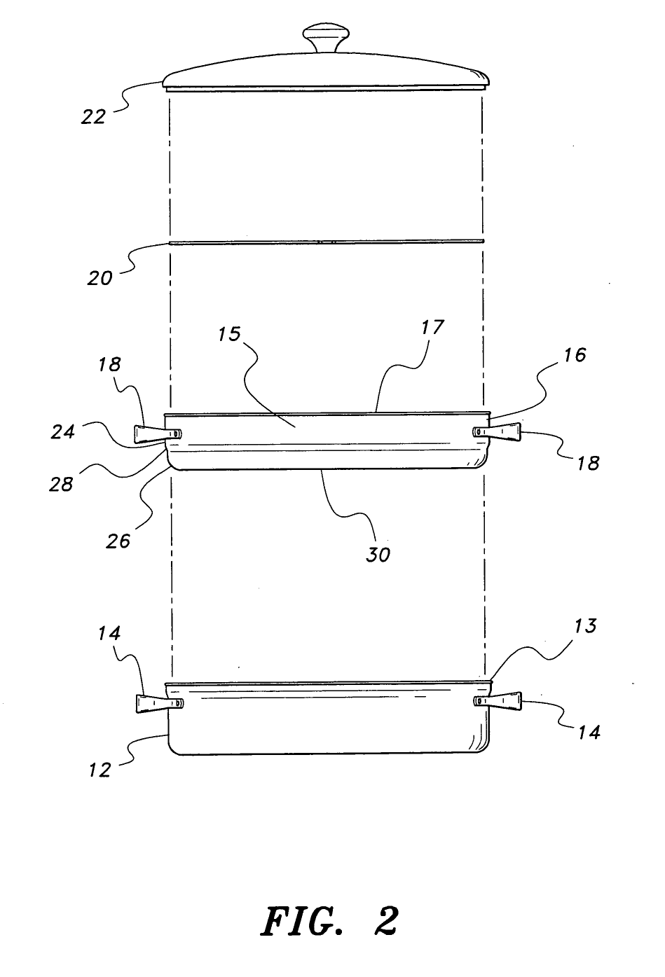

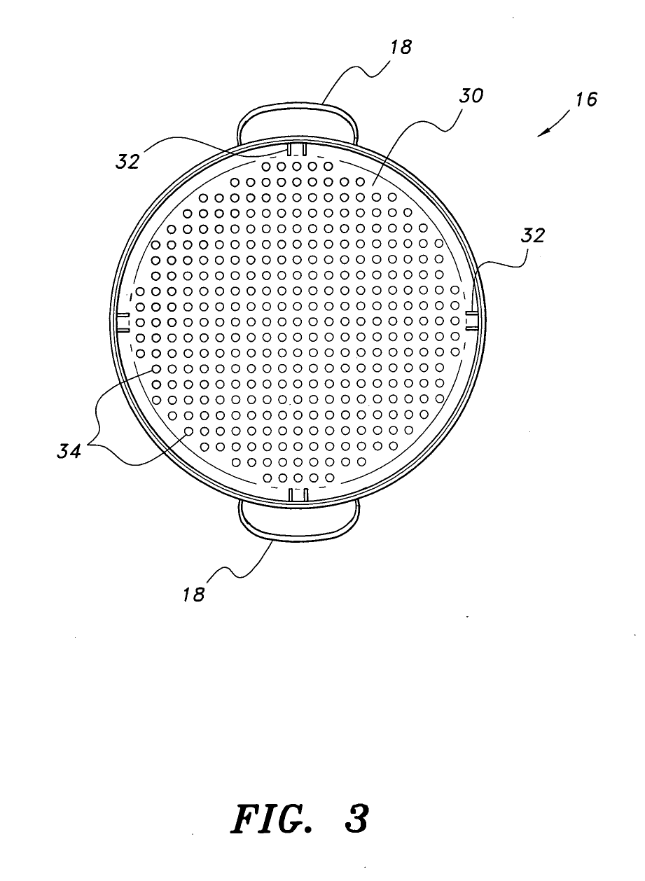

Food receptacle 16 is releasably supported on an upper peripheral edge 13 of the pot 12. As best shown in FIG. 2, the food receptacle 16 includes a lower wall 30 and at least one sidewall 15. As shown in FIG. 3, the lower wall 30 has a plurality of apertures 34 formed therethrough for the passage of steam therethrough when the volume of water W in the pot 12 is boiled. Cover 22 is further provided for removably covering and sealing the food receptacle 16, with the cover 22 being releasably supported on an upper rim 17 of the at least one sidewall 15. Handles 18, similar to handles 14 of pot 12, may be further provided. Food receptacle 16 is preferably formed from metal or any other suitably conductive material.

Preferably, as shown in FIG. 2, sidewall 15 includes an upper portion 24 and a lower portion 26. Lower portion 26 has a diameter less than the radius of upper portion 24, such that an annular recess 28 is formed therebetween. When food receptacle 16 is mounted on pot 12, the upper edge 13 of pot 12 is received within the annular recess 28 so that the lower portion 26 is received within the open interior region of pot 12. Although food receptacle 16 may have any desired dimensions or contouring, exemplary dimensions for a circular food receptacle 16 include a height of approximately 3½ inches, with upper portion 24 having a height of approximately 1½ inches, and lower portion 26 having a height of approximately 2 inches. The diameter of upper portion 24 may be approximately 12 inches. The pot 12 would similarly have an upper diameter of 12 inches in this example. Using these exemplary dimensions, pot 12 may have a height of approximately 5 inches. The apertures formed through the lower wall of the food receptacle may have diameters of approximately 3/16 of an inch.

As shown in FIG. 2, at least one tray 20 is removably received within the food receptacle 16. The at least one tray 20 is adapted for supporting food F to be cooked by the steam passing through the plurality of apertures 34. As shown in FIG. 3, at least one retaining member 32 is mounted within the food receptacle 16 for releasably retaining and positioning the at least one tray 20 therein.

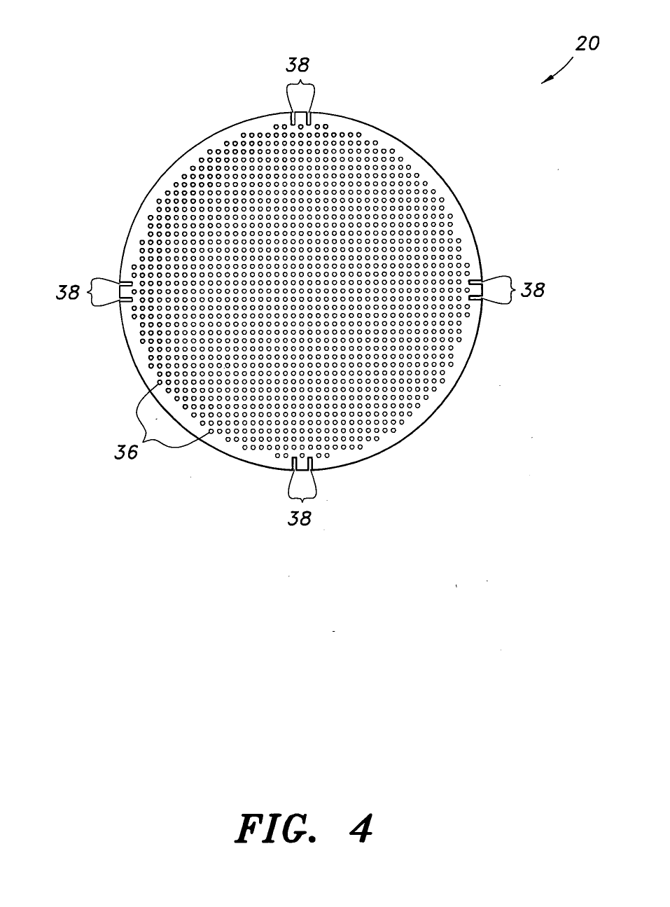

FIG. 4 shows tray 20 of the embodiment of FIG. 2. In the preferred embodiment, tray 20 is substantially circular, being configured to be received within the substantially circular food receptacle 16. Tray 20 has a plurality of apertures 36 formed therethrough with the diameter of each aperture 36 being preferably smaller than the diameter of each aperture 34, formed through the lower wall 30 of food receptacle 16. This allows food to be supported on tray 20 that would either fall through the larger apertures 34 of lower wall 30, or which benefits from the application of a lesser volume of steam. Tray 20 is preferably formed from metal or any other suitably conductive material.

Any suitable retaining member or members may be utilized to retain and position tray 20 within food receptacle 16, though in the preferred embodiment, as shown, four pairs of retaining members 32 are provided, with retaining members 32 being spaced apart at equal angular intervals about the perimeter of food receptacle 16. Complementary slots 38 are formed in the annular edge of tray 20, as shown in FIG. 4, with the retaining members 32 being releasably received within the slots 38.

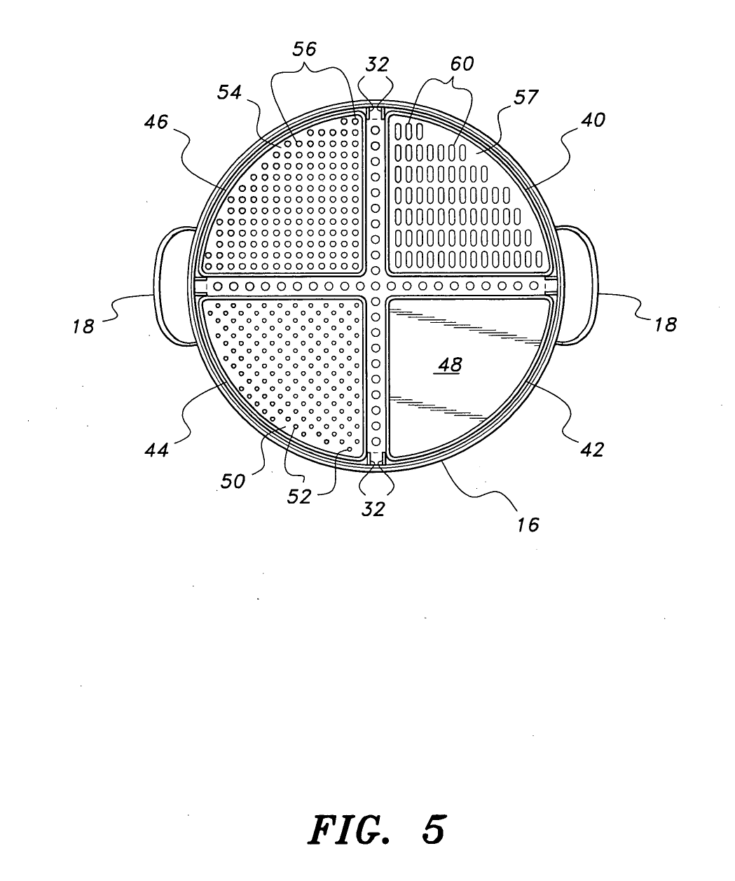

In the alternative embodiment of FIG. 5, four separate trays 40, 42, 44 and 46 are provided. It should be understood that any suitable number of trays may be provided, and that the four trays shown in FIG. 5 are shown for exemplary purposes only. Each tray 40, 42, 44, 46 is received within food receptacle 16 and rests on lower wall 30 thereof, and is retained and positioned between an adjacent pair of retaining members 32, as shown. As noted above, each retaining member is preferably formed as a pair of elements 32, thus allowing a central steam passage (having a cruciform shape in the exemplary embodiment of FIG. 5) to be formed therebetween.

Preferably, the trays 40, 42, 44 and 46 are each configured in a distinct and unique manner, allowing for the cooking or heating of differing types of food simultaneously. Tray 40 includes a lower wall 57 having a plurality of slots or slits 60 formed therethrough. Tray 42 includes a lower wall 48, which is formed as a continuous, planar surface, allowing food to be heated without direct application of steam. Trays 44 and 46 have respective lower walls 50, 54 having substantially circular apertures 52, 56 respectively formed therethrough. Apertures 52 have a smaller diameter than apertures 56, allowing for differing quantities and rates of steam application to food received therein. It should be understood that trays 40, 42, 44 and 46 are shown for exemplary purposes only, and that the nature of the openings, the size, and the shape of each tray may be varied, depending upon the types of food to be cooked or heated therein. Using the exemplary dimensions given above, each tray may have a height of approximately 3¼ inches.

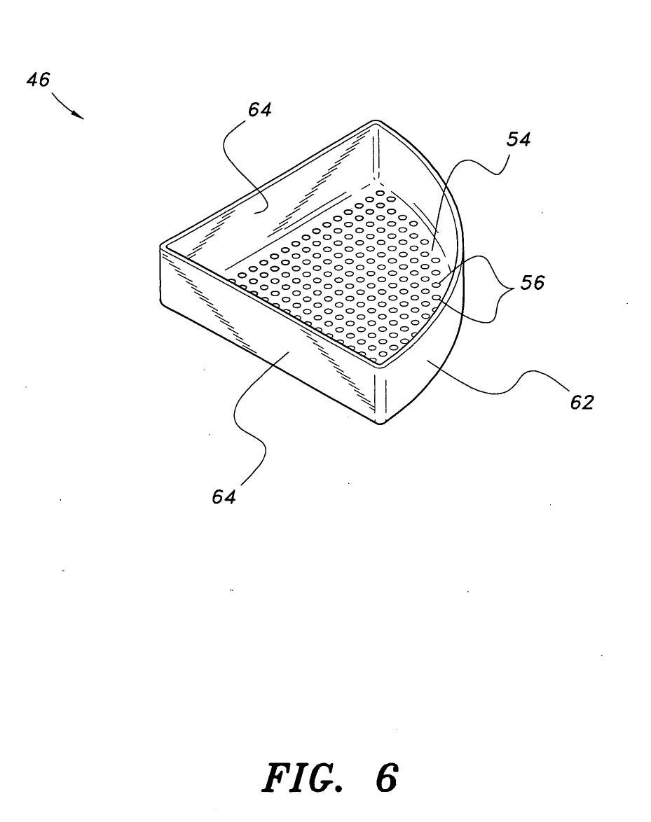

FIG. 6 illustrates one of the trays 46. Tray 46 includes lower wall 54, an outer, arcuate wall 62, to be positioned against sidewall 15 of food receptacle 16, and a pair of inner sidewalls 64. Each tray 40, 42, 44 and 46 is preferably formed from metal or any other suitable thermally conductive material. As noted above, the trays are shown for exemplary purposes only, and the trays may be provided in any configuration, including multiple ones of each type of tray. Further, in addition to retaining members 32, additional raised ridges may be formed on the lower wall of the food receptacle to better define the channels formed between adjacent trays.

It is to be understood that the present invention is not limited to the embodiments described above, but encompasses any and all embodiments within the scope of the following claims.

1. A food steamer, comprising:
a pot having an open interior region adapted for receiving a volume of water therein, the pot defining an upper peripheral edge;
a food receptacle having a lower wall and at least one sidewall, the lower wall having a plurality of apertures formed therethrough, the plurality of apertures being adapted for the passage of steam therethrough when the volume of water in the pot is boiled, the at least one sidewall defining an upper rim, the food receptacle being releasably supported on the upper peripheral edge of the pot; and
at least one tray removably received within the food receptacle, the at least one tray being adapted for supporting food to be cooked by the steam passing through the plurality of apertures.

2. The food steamer as recited in claim 1, wherein the at least one sidewall of said food receptacle comprises an upper portion and a lower portion, a radius of the lower portion being less than a radius of the upper portion so that an annular recess is defined therebetween, the upper peripheral edge of said pot being received within the annular recess.

3. The food steamer as recited in claim 2, further comprising means for retaining and positioning said at least one tray within said food receptacle.

4. The food steamer as recited in claim 3, further comprising at least one retaining member mounted to an upper surface of the lower wall of said food receptacle.

5. The food steamer as recited in claim 4, wherein said at least one tray has at least one slot formed therein for receiving the at least on retaining member.

6. The food steamer as recited in claim 5, wherein said at least one tray has a planar contour and has a plurality of apertures formed therethrough.

7. The food steamer as recited in claim 4, wherein the at least one retaining member comprises a plurality of retaining members, said at least one tray being removably received between adjacent ones of the plurality of retaining members.

8. The food steamer as recited in claim 7, wherein the plurality of retaining members comprises a plurality of pairs of spaced apart retaining members.

9. The food steamer as recited in claim 8, wherein said at least one tray comprises a plurality of trays, each said tray being respectively, removably received between adjacent ones of said pairs of spaced apart retaining members.

10. The food steamer as recited in claim 9, wherein each said tray is dimensioned so that open channels are formed between adjacent ones of said trays when said plurality of trays are positioned between the adjacent ones of said pairs of spaced apart retaining members.

11. A food steamer, comprising:
a pot having an open interior region adapted for receiving a volume of water therein, the pot defining an upper peripheral edge;
a food receptacle having a lower wall and at least one sidewall, the lower wall having a plurality of apertures formed therethrough, the plurality of apertures being adapted for the passage of steam therethrough when the volume of water in the pot is boiled, the at least one sidewall defining an upper rim, the food receptacle being releasably supported on the upper peripheral edge of the pot;
at least one tray removably received within the food receptacle, the at least one tray being adapted for supporting food to be cooked by the steam passing through the plurality of apertures; and
means for retaining and positioning said at least one tray within said food receptacle.

12. The food steamer as recited in claim 11, wherein the at least one sidewall of said food receptacle comprises an upper portion and a lower portion, a radius of the lower portion being less than a radius of the upper portion so that an annular recess is defined therebetween, the upper peripheral edge of said pot being received within the annular recess.

13. The food steamer as recited in claim 12, further comprising at least one retaining member mounted to an upper surface of the lower wall of said food receptacle.

14. The food steamer as recited in claim 13, wherein said at least one tray has at least one slot formed therein for receiving the at least on retaining member.

15. The food steamer as recited in claim 14, wherein said at least one tray is a planar and has a plurality of apertures formed therethrough.

16. The food steamer as recited in claim 13, wherein the at least one retaining member comprises a plurality of retaining members, said at least one tray being removably received between adjacent ones of the plurality of retaining members.

17. The food steamer as recited in claim 16, wherein the plurality of retaining members comprises a plurality of pairs of spaced apart retaining members.

18. The food steamer as recited in claim 17, wherein said at least one tray comprises a plurality of trays, each said tray being respectively removably received between adjacent ones of said pairs of spaced apart retaining members.

19. The food steamer as recited in claim 18, wherein each said tray is dimensioned so that open channels are formed between adjacent ones of said trays when said plurality of trays are positioned between the adjacent ones of said pairs of spaced apart retaining members.

20. A food steamer, comprising:
a pot having an open interior region adapted for receiving a volume of water therein, the pot defining an upper peripheral edge;
a food receptacle having a lower wall and at least one sidewall, the lower wall having a plurality of apertures formed therethrough, the plurality of apertures being adapted for the passage of steam therethrough when the volume of water in the pot is boiled, the at least one sidewall defining an upper rim, the food receptacle being releasably supported on the upper peripheral edge of the pot, the at least one sidewall comprising an upper portion and a lower portion, the lower portion having a radius less than the upper portion so that an annular recess is defined therebetween, the upper peripheral edge of said pot being received within the annular recess; and
at least one tray removably received within the food receptacle, the at least one tray being adapted for supporting food to be cooked by the steam passing through the plurality of apertures.
